(19) United States
(12) Patent Application Publication
(10) Pub. No.: US 2010/0066754 A1
(43) Pub. Date: Mar. 18, 2010

(54) CONTROL METHOD OF BACKLIGHT SOURCE AND DISPLAY DEVICE

(75) Inventor: Yasunori Kuroda, Kato (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/557,165

(22) Filed: Sep. 10, 2009

(30) Foreign Application Priority Data
Sep. 16, 2008 (JP) 2008-236761

(51) Int. Cl. G09G 3/36; G09G 5/02; G09G 5/00

(52) U.S. Cl. 345/589; 345/207; 345/102

(57) ABSTRACT

A method for controlling a backlight for illuminating a transmissive display panel includes measuring an amount of current supplied to the transmissive display panel, and controlling brightness caused by the backlight source on the basis of the amount of the current. Further the method includes storing data of a threshold value to be compared with the amount of the current, and controlling the brightness to decrease when the transmissive panel is a normally white type and the amount of the current is smaller than the threshold value data or when the transmissive panel is a normally black type and the amount of the current is larger than the threshold value data.

### CROSS-REFERENCE TO RELATED APPLICATIONS

This application is based upon and claims the benefit of priority of the prior Japanese Patent Application No. 2008-236761, filed on Sep. 16, 2008, the entire contents of which are incorporated herein by reference.

### FIELD

The embodiments discussed herein are related to a control method of a backlight for a transmissive type display panel and a display device.

### BACKGROUND

A flat screen display device using a liquid crystal panel (LCD panel) and the like is widespread as a display device of a computer and a television. In general, a transmissive-type LCD panel is used and brightness of an image is controlled with a backlight.

The display device using the backlight requires a higher luminance in recent years. A higher luminance is preferable for clear viewing when watching a moving image on a television program, while an image with a higher luminance gives a dazzling feeling upon creating and editing a document by using a computer in many cases.

For adjusting a luminance or brightness of screen, Japanese Laid-open Patent Publication 2005-122187 has proposed a method for adjusting the luminance of the display device in accordance with intensity of ambient light. Japanese Laid-open Patent Publication 2006-164842 has proposed the use of a cold-cathode tube (FL tube) or LED used for adjusting a luminance of the screen.

Further it is also known that a method enables analyzing distribution of luminance of the image for adjusting a luminance or brightness of screen.

That is, FIG. 11 shows the structure of a conventional scaler 80 for displaying and driving a liquid crystal panel. FIG. 11 illustrates one of a scaler 80 for use of brightness control of a liquid crystal display panel. The scaler 80 includes: a video converter EH; a look-up table 84; a Y-data analyzer 85; a brightness changing unit 86; a PMW controller 87; and the like. The video converting section EH comprises: an RGB/YUV converter 81; a YUV/RGB converter unit 82; and a Y-data extractor 83.

The RGB/YUV converter 81 converts an inputted RGB video signal S1 into YUV format as a color-spatial conversion. The Y-data extractor 83 extracts Y data (luminance data) from the video signal of YUV format. The Y-data analyzer 85 obtains the Y data distribution from the inputted Y data. On the basis of the Y data distribution the brightness changing unit 86 generates a signal for changing the brightness of the backlight. In this case, when the Y-data is concentrated near the maximal value thereof, the brightness changing unit 86 generates a signal for reducing the brightness. When the Y-data is not concentrated near the maximal value, the brightness changing unit 86 generates a signal for keeping the current situation.

The PMW controller 87 generates a signal S11 for a pulse width modulation (PWM) on the basis of a signal outputted from the brightness changing unit 86. The signal S11 is inputted to a brightness controller 88 of an inverter 13j in which a voltage is varied according to the signal 11 and applied to the cold-cathode tube, thereby controlling the luminance of the cold-cathode tube.

The YUV/RGB converter unit 82 converts the video signal in YUV format into the video signal in RGB format as the color space conversion. Then, the video signals S2 in RGB format are converted based on the look-up table 84 and are outputted. The video signals S2 are inputted to a liquid crystal panel, thereby driving a liquid crystal panel via a driver circuit.

### SUMMARY

According to an aspect of the invention, a method for controlling a backlight for illuminating a transmissive display panel includes measuring an amount of current supplied to the transmissive display panel and controlling brightness caused by the backlight source on the basis of the amount of the current.

According to another aspect of the invention, a display device including a transmissive type panel and a backlight includes a detector for detecting an amount of current supplied to the transmissive panel and a brightness controller for control brightness caused by the backlight source on the basis of the amount of the current.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a display device using a liquid crystal display;

FIG. 2 is a schematic circuit diagram illustrating a current detector;

FIG. 3 is another schematic circuit diagram illustrating a current detector;

FIGS. 4A and 4B each illustrates a relationship between detected current data and brightness;

FIG. 5 is a diagram explaining a determining whether a liquid crystal panel is a normally white or a normally black type;

FIG. 6 is a schematic circuit diagram illustrating a liquid crystal panel;

FIG. 7 is an operation chart illustrating a brightness control for the normally white panel;

FIG. 8 is an operation chart illustrating a brightness control for the normally black panel;

FIG. 9 is an operation chart illustrating determination whether a liquid crystal panel is a normally white or a normally black type;

FIG. 10 is a diagram illustrating an information processing apparatus using one of the present embodiments; and

FIG. 11 is a conventional scaler used in a liquid crystal display device.

### DESCRIPTION OF EMBODIMENTS

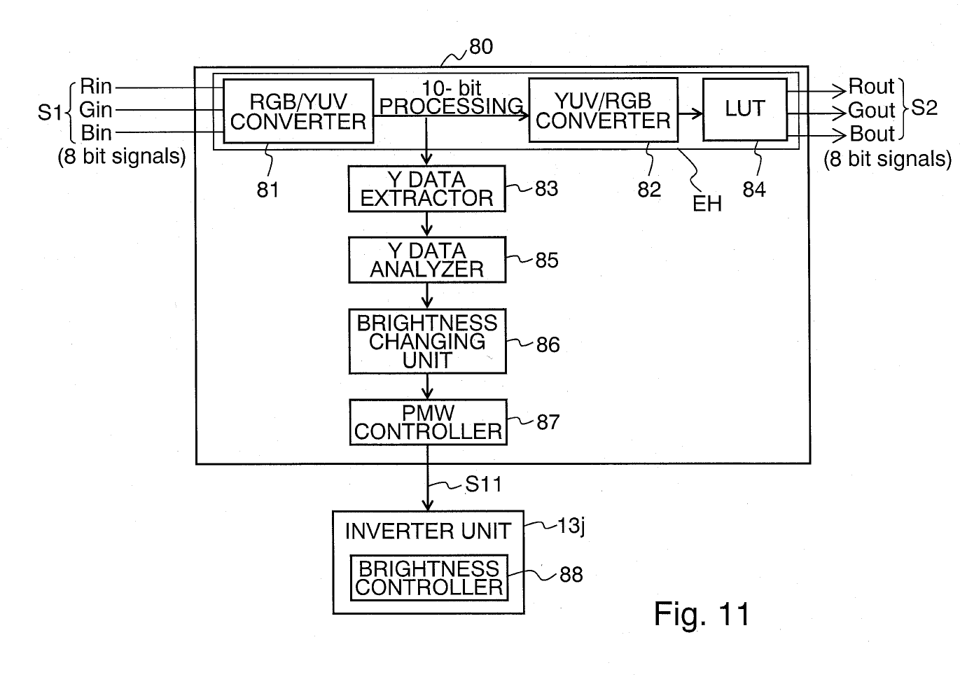

The conventional control method of the backlight shown in FIG. 11 uses complicated conversion in which the inputted RGB video signals S1 are temporarily converted into YUV video signals, the Y-data is extracted from the converted signals, and the signal is thereafter converted into RGB video signals again.

In order to accurately obtain the video signal S2, the video signals S1 and S2 have 8 bits for respective color signals, RGB. However, the video converting section EH performs processing with 10 bits for the respective colors. Therefore, a processing circuit is complicated, a circuit for this processing, such as an integrated circuit device, is increased, and the implementation space is also increased and costs also rise.

The embodiments according to the present invention is devised in consideration of the problem, and it is an object of the embodiments to provide a control method of a backlight in which luminance of the backlight is controlled in accordance with a video signal with a simple circuit and low costs and a display device.

As a method according to an embodiment of the present invention, the level of current supplied to the display panel is detected and the luminance of the backlight may be controlled on the basis of the detected level of the current which is applied to a transmissive-type display panel.

Since the luminance of the backlight is controlled on the basis of the level of the current supplied to the display panel, the conventional complicated processing circuit may not need to be disposed and the luminance of the backlight may be controlled with a simple circuit.

Further, the detected current is compared with a threshold. The luminance of the backlight may be controlled to be reduced when the detected current is lower than the threshold on the display panel in a normally white type panel or when the detected current is higher than the threshold on the display panel in a normally black type panel.

Hereinbelow, a description of the embodiments will be given.

According to the embodiment, the level of current I supplied to a display panel is detected and the luminance of the backlight is controlled on the basis of the level of the detected current I. Then, the detected current I is supplied to an inverter which controls lighting-on the backlight such as a cold-cathode tube in accordance with the detected current I.

In the liquid crystal display panel of the normally white type, a white image in a full-screen requires a minimum current supplied to the panel. On the other hand, a white image in a full-screen requires a maximum current supplied to the panel when the panel is the normally black type.

Therefore, the inverter may be controlled by monitoring the current I supplied to the display panel.

In the case of normally white type of the panel, the inverter is controlled so as to set the brightness (luminance) of the backlight low when the current I is small. On the contrary, the inverter is controlled so as to the brightness high when the current is large. Further, it is preferable to control the inverter so that the brightness is adjusted linearly with the analogue current I value.

The above-mentioned control may not need the RGB/YUV converter and the YUV/RGB converter that are conventionally required. Further, since an advanced image analyzing device is not required for controlling the brightness of screen, costs will be reduced and the space is saved.

In other words, the detected current I is compared with a threshold “th” and the control is performed so that the luminance of the backlight is reduced when the detected current I is lower than the threshold th in the normally white type panel of the display panel or when the detected current I is higher than the threshold th in the normally black type panel of the display panel.

Alternatively, analog control is performed so that the luminance of the backlight is reduced when the detected current I is lower in the normally white type panel of the display panel and when the detected current I is higher in the normally black type of the display panel.

Hereinbelow, a specific description will be given.

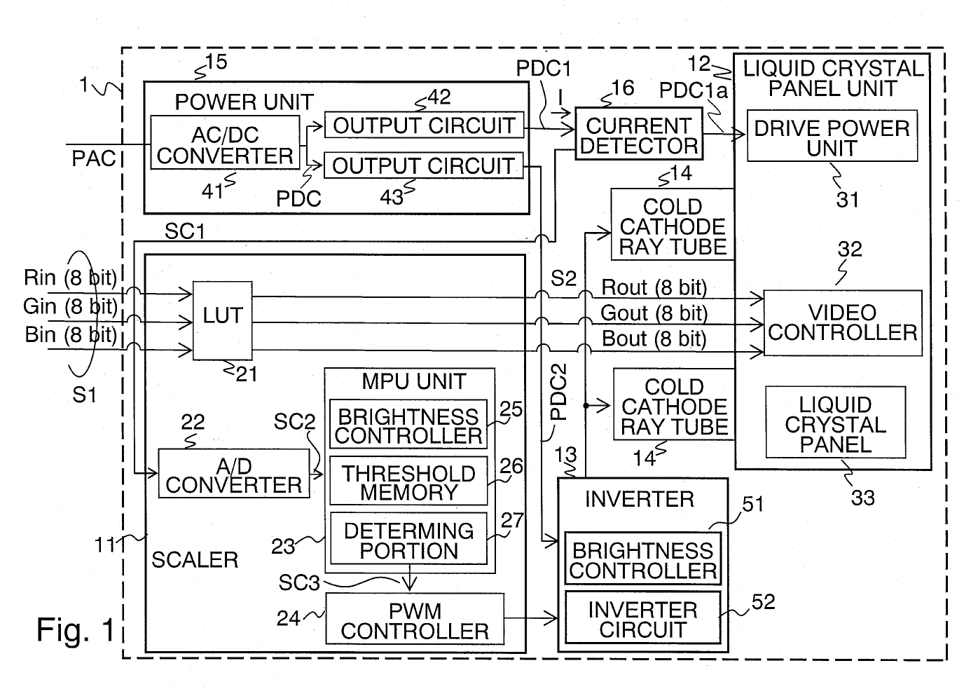

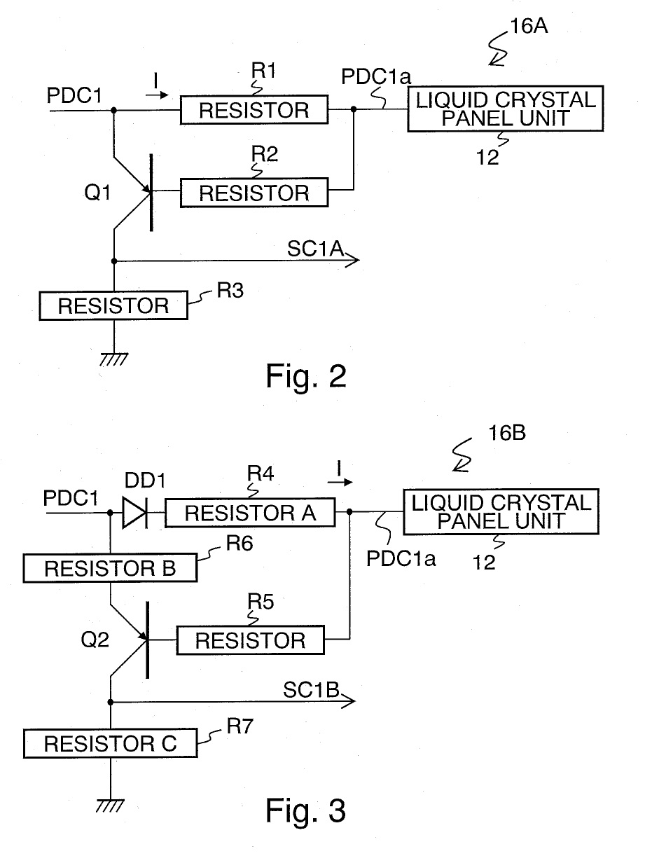

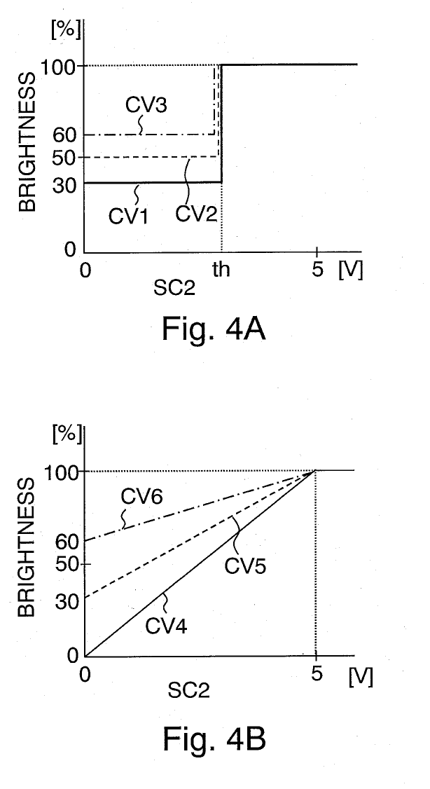

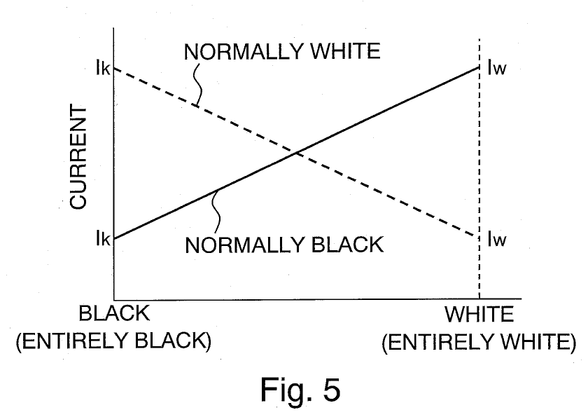

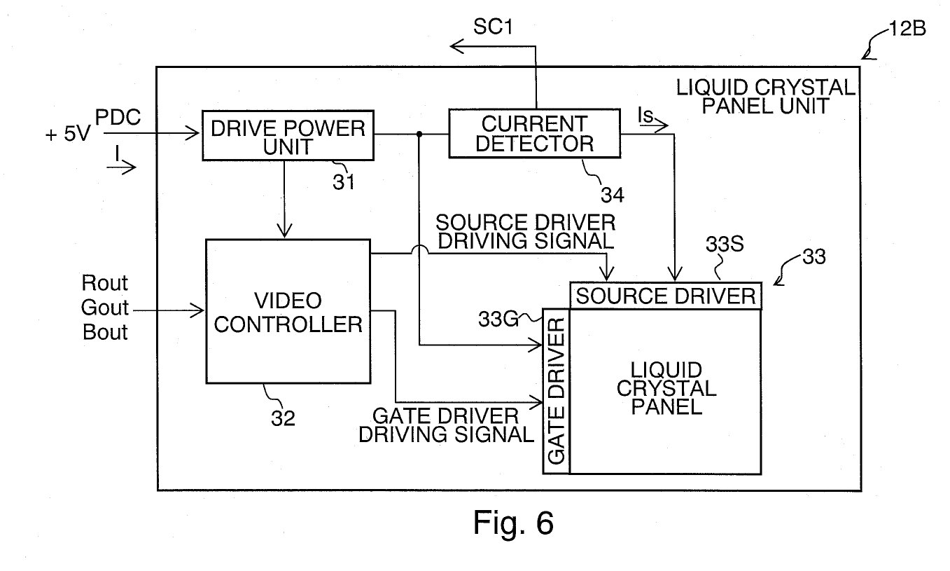

FIG. 1 is a block diagram illustrating a circuit of a display device 1 according to an embodiment of the present invention. FIG. 2 is a diagram illustrating a circuit of a current detector 16A as an example. FIG. 3 is a diagram illustrating a circuit of a current detector 16B as another example. FIG. 4 is a diagram illustrating examples of relationships between detecting data SC2 and the luminance. FIG. 5 is a diagram for explaining a determining operation in a determining portion 27. FIG. 6 is a block diagram illustrating an example of a circuit of a liquid crystal panel unit 12.

Referring to FIG. 1, the display device 1 using a transmissive liquid crystal panel 33 is shown. The display device 1 comprises: a scaler 11; a liquid crystal panel unit 12; an inverter 13; a cold-cathode tube 14; a power unit 15; and a current detector 16.

The scaler 11 has a look-up table (LUT) 21; an A/D converter 22; an MPU unit 23; and a PWM controller 24.

The MPU unit 23 comprises: a brightness controller 25; a threshold memory 26; and a determining portion 27. The MPU unit 23 further has a micro processing unit (MPU) or a central processing unit (CPU), a memory, and other electrical elements, and executes various processing, operation, or control by performing a program. The MPU processing realizes functions of the brightness controller 25 and the determining portion 27.

The RGB video signals (image signals) S1 is inputted into the scaler 11 in which the signals S1 are converted to RGB video signals S2 by using the look-up table 21. The look-up table 21 may be a conventional well-known one.

The scaler 11 controls also the luminance (brightness) of the cold-cathode tube 14 as the backlight via the inverter 13 on the basis of the level of the current I detected by the current detector 16. That is, the A/D converter 22 converts the detecting signal SC1 corresponding to the current I into the detecting data SC2 with 8 bits. The detecting signal SC1 can be obtained in a form of a binary signal (detecting signal SC1A) indicating “H (high)” and “L (low)” or a form of an analog signal (detecting signal SC1B) that continuously changes from the minimal value to the maximal value. The each form of the signal SC1 will be described later.

The brightness controller 25 determines whether or not the luminance of the cold-cathode tube 14 needs to be changed on the basis of the detecting data SC2. When the luminance needs to be changed, the brightness controller 25 outputs a signal SC3 necessary for the change to the PWM controller 24. The PWM controller 24 controls the inverter 13 so that the luminance of the cold cathode ray tube 14 reaches the luminance corresponding to the signal SC3. In detail, the brightness controller 25 compares the detecting data SC2 with the threshold th stored in the threshold memory 26.

In the normally white type panel of the display device 1, when the detecting data SC2 is lower than the threshold th, it is controlled to reduce the luminance of the backlight. In the normally black type panel of the display device 1, when the detecting data SC2 is higher than the threshold th, it is controlled to reduce the luminance of the backlight as shown by curves CV1 to CV3 (refer to FIG. 4A).

In an example shown in FIG. 4A, when the detecting data SC2 is lower than the threshold th, the luminance is adjusted to 30% (curve CV1), 50% (curve CV2), and 60% (curve CV3), respectively. When the detecting data SC2 is the threshold th or more, the luminance is 100%. For example, a voltage of 2.5V is used as the threshold th.

Thus, when the video signal S1 indicates a video image (video image with high luminance) brighter than an image with a predetermined value, it is controlled to reduce the luminance of the backlight.

The predetermined value is generally determined depending on the level of the threshold th. When the detecting signal SC1 is a binary signal (detecting signal SC1A), the predetermined value is substantially determined depending on a threshold upon obtaining a binary signal in many cases.

Therefore, upon using the current detector 16A shown in FIG. 2, as will be described later, a state of the detecting signal SC1, i.e., “L” (0V) or “H” (5V) is determined depending on the threshold adjusted by resistance values of resistors R1 to R3. Therefore, the threshold of the current detector 16A may be a threshold according to the embodiment. In this case, the threshold th stored in the threshold memory 26 may be not required and the brightness controller 25 may control the PWM controller 24 on the basis of the detecting data SC2. In the example, the luminance is adjusted to two states. However, the adjustment of the luminance may have three states, four states, or more.

Alternatively, the brightness controller 25 may be structured to perform the following operation.

That is, in the normally white type panel of the display device 1, as the detecting data SC2 is lower (detecting signal SC1 is lower), the luminance of the backlight is controlled to be reduced. In the normally black type panel of the display device 1, as the detecting data SC2 is higher (detecting signal SC1 is higher), the luminance of the backlight is controlled to be reduced (refer to FIG. 4B). When the detecting signal SC1 is an analog signal (detecting signal SC1B) that continuously changes, the control may be effective.

In an example shown in FIG. 4B, the luminance is individually adjusted to 0 to 100% (curve CV4), 30 to 100% (curve CV5), and 60 to 100% (curve CV6) depending on the level of the detecting data SC2. Each curve shown in FIG. 4B is a straight line in the range of 0 V to 5 V, it is preferable to vary the brightness along a quadratic, a cubic, or a logarithmic curves in a predetermined range of SC2.

Incidentally, the normally white means that a white image (bright image) is displayed when a voltage is not applied to a liquid crystal material of the liquid crystal panel 33. The normally black means that a black image (dark image) is displayed when a voltage is not applied.

The determining portion 27 determines whether the liquid crystal panel 33 is a normally white or a normally black type. Assuming that the current detector 16 detects a current Iw at displaying a fully white image on the screen of the liquid crystal panel 33 and a current Ik at displaying a fully black image, then Iw is smaller that Ik, that is Iw<Ik, then the liquid crystal panel 33 is determined as the normally white type by the determining portion 27. In the scaler 11, the fully white and black images may be generated by a computer (not shown) or by using data, which stored for example in a memory provided in the MPU unit 23, corresponding to each of the images.

Data of the above described fully white and black images may be generated by a video signal STS with RGB signals having “0” for all pixels and a video signal STD with RGB signals having “255” for all pixels are created and which of the video signal STS or STD corresponds to the video signal generating the fully white or black image is depend on the type of the panel. The created signals are outputted as the video signals S2, and are displayed on the liquid crystal panel 33. The current detector 16 detects the current I when the displayed signals are displayed. When the liquid crystal display panel 33 is viewed and the video image has intensive highlight or a fully white image, the current I is set as the current Iw. When the video image has deep shadow or a fully black image, the current I is set as the current Ik.

FIG. 5 illustrates schematically the relationship between the detected current such as SC1 the current detector 16 and the brightness of the image according to the detected SC1. As shown in FIG. 5, a relation of Iw<Ik is obtained in the normally white type panel. In the normally black type panel, a relation of Iw>Ik is obtained. Therefore, as described above, the two-type current Iw and Ik is compared with each other, thereby determining whether the image is in the normally white type panel or normally black type panel. This determination may be performed by the determination portion 23.

The liquid crystal panel unit 12 comprises: a drive power unit 31; a video controller (LVDS) 32; and a liquid crystal panel 33. The drive power unit 31 generates a voltage necessary for an operation of units in the panel 12 on the basis of a DC voltage PDC1a to be inputted. The video controller 32 is a control circuit for controlling the liquid crystal panel 33 on the basis of the video signal S2 outputted from the scaler 11, thereby displaying the video image. The liquid crystal panel 33 is an active-matrix type one in the embodiment, while other types of a liquid crystal panel may be used.

The inverter 13 includes a brightness controller 51 and an inverter circuit 52. The brightness controller 51 controls the inverter circuit 52 in response to a PWM control signal from the PWM controller 24. The inverter circuit 52 supplies a high AC voltage to the cold-cathode tube 14 so as to light-on the cold-cathode tube 14. The brightness controller 51 controls the current flowing to the cold-cathode tube 14 by the inverter circuit 52, thereby controlling the luminance of the cold-cathode tube 14. It is possible to use a well-known inverter applicable to the cold-cathode tube 14 as the backlight. The number of the cold-cathode tubes 13 may be one or more depending the screen size of the liquid crystal panel 33 or the required quality of the image on the screen.

The power unit 15 comprises: an AC/DC converter 41; an output circuit 42 for panel driving; and an output circuit 43 for inverter driving. The AC/DC converter 41 converts an AC voltage PAC for commercial use to be inputted into a DC voltage PDC. The output circuit 42 for panel driving outputs a DC voltage PDC1 for driving the liquid crystal panel unit 12. The output circuit 43 for inverter driving outputs a DC voltage PDC2 for driving the inverter 13.

The current detector 16 detects the value or level of current I supplied to the liquid crystal panel unit 12. A method for detecting the current I by the current detector 16 includes a first current-detecting method and a second current-detecting method according to the embodiment.

With the first current-detecting method, the current detector 16 outputs the binary detecting signal SC1 depending on the value or level of the current I supplied to the liquid crystal panel unit 12.

Referring to FIG. 2, the current detector 16A comprises resistors R1, R2 and R3 and a transistor Q1. When the current I is low and a voltage drop through the resistor R1 is equal to or less than the forward voltage drop of the transistor Q1, the transistor Q1 is OFF-state and the detecting signal SC1A is 0 volts. When a voltage drop through the resistor R1 is equal to or more than the forward voltage drop, the transistor Q1 is ON-state and the detecting signal SC1A has a similar voltage to the DC voltage PDC1. If the DC voltage PDC1 is, e.g., 5V, the detecting signal SC1A is 0V (i.e., a low state or “L” state) or 5V (i.e., a high state or “H” state). The adjustment of resistances of the resistors R1 to R3 enables the threshold discriminating L and H states to be adjusted, because the relationship between the value of current I and the levels of the detecting signal SC1A varies by the values of resistors R1 to R2.

With the second current-detecting method, the current detector 16 outputs the detecting signal SC1 of a voltage value depending on the level of the current I supplied to the liquid crystal panel unit 12. Referring to FIG. 3, the current detector 16B comprises a diode DD1, a transistor Q2 and resistors R4 to R7, where the diode DD1 and the resistor R1 are serially connected between the liquid crystal panel unit 12 and the input terminal for receiving the direct voltage PDC1. In this embodiment, the detecting signal SC1B corresponds to a voltage value amplified by the transistor Q2 depending on the ratio of the value of resistor 6 to the value of resistor 7 with respect to the current I flowing to the resistor R4. That is, the detecting signal SC1B has a voltage value in proportional to the current I flowing to the resistor R4. The adjustment of the resistances of the resistors R4 to R7 enables the adjustment of a relationship between the level of the current I and the level of the detecting signal SC1B, i.e., voltage values and or inclination.

The use of the detecting signal SC1B with the second current-detecting method enables each of control operations shown in FIGS. 4A and 4B. That is, the second current-detecting method enables the control of luminance on the basis of the detecting signal SC1B with two steps. Further, such a control operation is possible that the luminance of the backlight continuously changes depending on the detecting signal SC1B indicating the voltage value.

### [Liquid Crystal Panel Unit According to Another Embodiment]

Next, a description will be given of the liquid crystal panel unit 12B according to another embodiment referring to FIG. 6.

With the display device 1 according to the embodiment previously described, the current detector 16 detects the current I flowing to the entire liquid crystal panel unit 12. In this embodiment, the detection is performed to detect the current supplied to a source driver of the liquid crystal panel 33 in the liquid crystal panel unit 12B not to the current I flowing to the entire liquid crystal panel unit 12 (in FIG. 1).

The liquid crystal panel unit 12B comprises a drive power unit 31, a video controller (LDS) 32, a liquid crystal panel 33, and a current detector 34. The drive power unit 31 and the video controller 32 may be identical or similar to the ones previously described. The liquid crystal panel 33 is a TFT-active-matrix-type one and includes a gate driver 33G and a source driver 33S to drive a plurality of elements of the liquid crystal panel 33 arrayed in a row and a column of a matrix.

The drive power unit 31 supplies power to the video controller 32 and the liquid crystal panel 33. Power is separately supplied to the gate driver 33G and the source driver 33S in the liquid crystal panel 33.

The video controller 32 outputs a gate driver driving signal to the gate driver 33G, and outputs a source driver driving signal (data for driving source driver) to the source driver 33S.

The current detector 34 detects current Is supplied to the source driver 33S from the drive power unit 31. The current detector 34 has the same structure as that of the current detector 16. When the liquid crystal panel 12B has the current detector 34 as mentioned above, the current detector 16 is not required.

That is, the detecting signal SC1 is outputted depending on the current Is detected by the current detector 34. Similarly to the foregoing, the scaler 11 performs processing and operation for controlling the luminance of the cold-cathode tube 14 on the basis of the detecting signal SC1.

When the current detector 34 detects the current Is, it is possible to determine whether or not the luminance of the cold-cathode tube 14 needs to be changed and how the luminance is set after the change, more properly than the case of detecting the current I of the entire liquid crystal panel 33 by the current detector 16. It is preferable to control the luminance of the backlight according to an angle of twist of liquid crystal molecules in the liquid crystal panel 33. Since the current Is is more relative to the angle than the current I which flows into the whole of the liquid crystal panel unit 12 (FIG. 1), the control of the luminance of the backlight depending on the current Is may be more preferable than the control the current I.

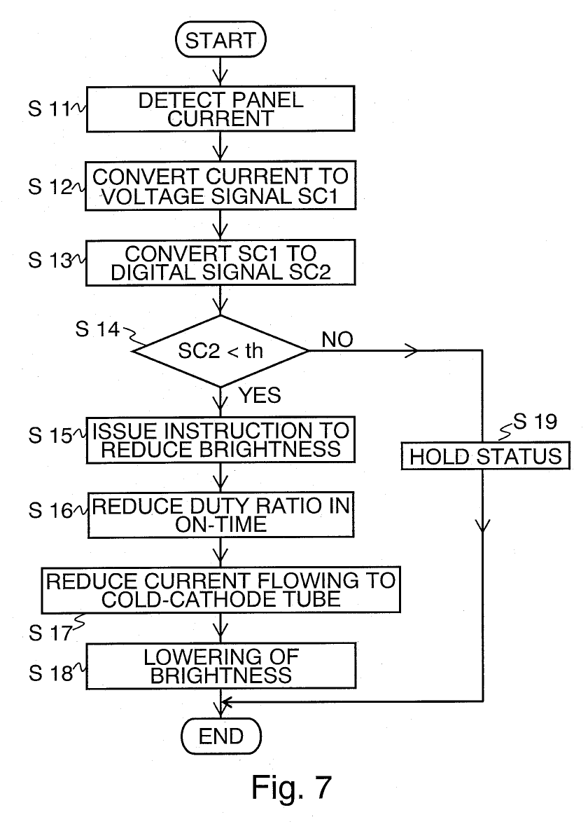

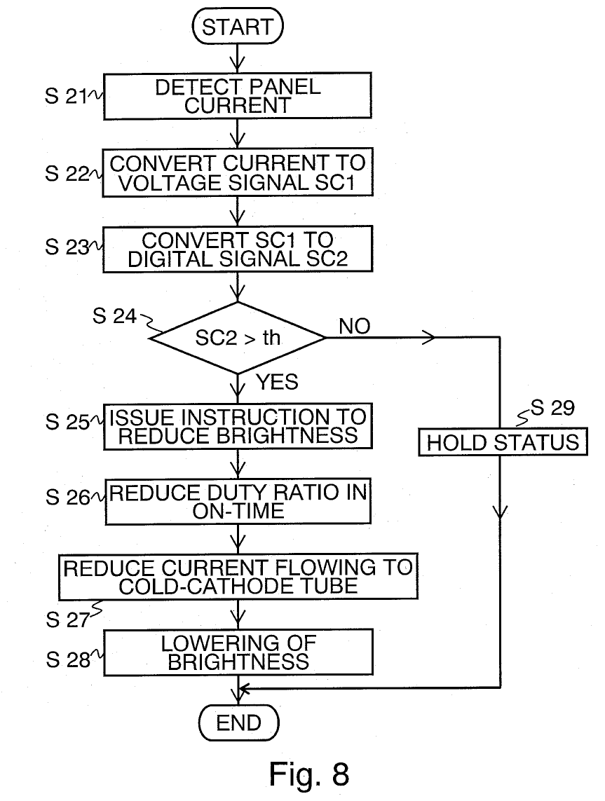

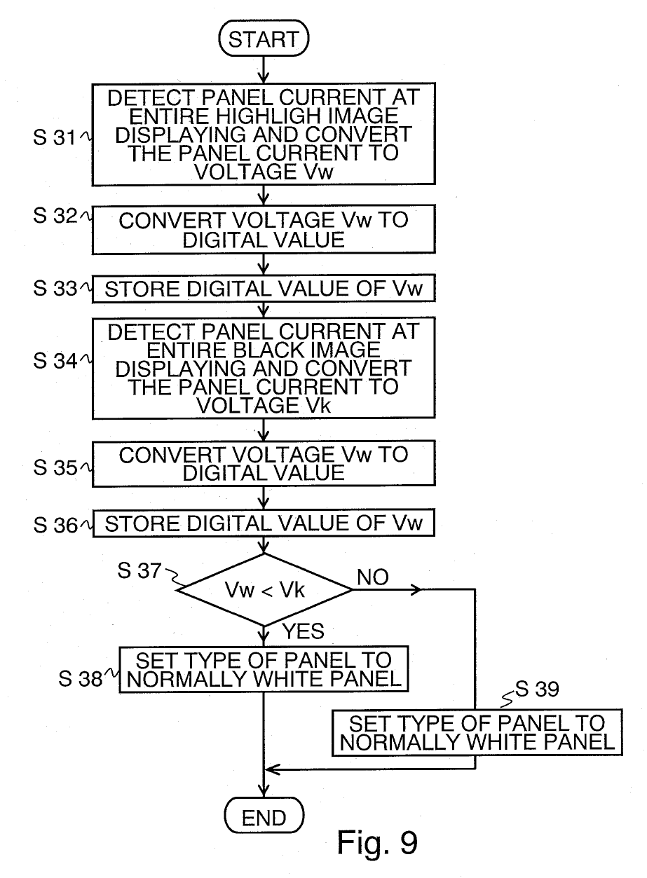

Next, a description will be given of the operation of the display device 1 with reference to an operation chart. FIG. 7 is an operation chart illustrating a luminance control in the normally white type panel. FIG. 8 is an operation chart illustrating a luminance control in the normally black type panel. FIG. 9 is an operation chart illustrating processing for determining the panel in the determining portion 27.

Referring to FIG. 7, the current I flowing to the liquid crystal panel unit 12 is detected (S11). The detected current I is converted into a voltage and is further set as the detecting signal SC1 (S12). The detecting signal SC1 is converted into the detecting data SC2 as digital data (S13). The detecting data SC2 is compared with the threshold th (S14).

When the detecting data SC2 is lower than the threshold th (YES in S14), the brightness controller 25 issues an instruction to reduce the brightness (S15). In accordance therewith, the PWM controller 24 performs PWM control to reduce the duty ratio in ON-time (S16). In accordance therewith, the inverter 13 performs a control operation to reduce the current flowing to the cold-cathode tube 14 (S17). As a result, the luminance of the display operation of the liquid crystal panel unit 12 (S18). When the detecting data SC2 is higher than the threshold th (NO in S14), the brightness controller 25 keeps the current situation (S19).

Referring to FIG. 8, the current I flowing to the liquid crystal panel unit 12 is detected (S21). The detected current I is converted into a voltage and is further set as the detecting signal SC1 (S22). The detecting signal SC1 is converted into the detecting data SC2 as digital data (S23). The detecting data SC2 is compared with the threshold th (S24).

When the detecting data SC2 is higher than the threshold th (YES in S24), an instruction to reduce the brightness is issued (S25). The PWM control is performed to reduce the duty ratio in the ON-time (S26). The current flowing to the cold-cathode tube 14 is reduced (S27). As a consequence, the luminance of the display operation in the liquid crystal panel unit 12 is reduced (S28). When the detecting data SC2 is lower than the threshold th (NO in S24), the brightness controller 25 keeps the current situation (S29).

Referring to FIG. 9, the current I flowing to the liquid crystal panel unit 12 is detected in the case of a video image with intensive highlight (a video image with a white image on a whole screen) and is then converted into a voltage Vw (S31). The voltage Vw is converted into digital data (S32), and the digital data is stored to the memory (S33). The current I flowing to the liquid crystal panel unit 12 is detected in the case of a video image with intensive highlight and is then converted into a voltage Vk (S34). The voltage Vk is converted into digital data (S35), and the digital data is stored to the memory (S36).

The voltage Vw is compared with the voltage Vk as the digital data (S37). When the voltage Vw is lower than the voltage Vk (YES in S37), it is determined that the image is in the normally white type panel and the result is stored to the memory (S38). When the voltage Vw is higher than the voltage Vk (NO in S37), it is determined that the image is in the normally black type panel and the result is then stored to the memory (S39).

According to the embodiment, the scaler 11 and the inverter 13 correspond to luminance control means according to the present invention. Further, the current detector 16 and the current detector 34 correspond to current detecting means according to the present invention.

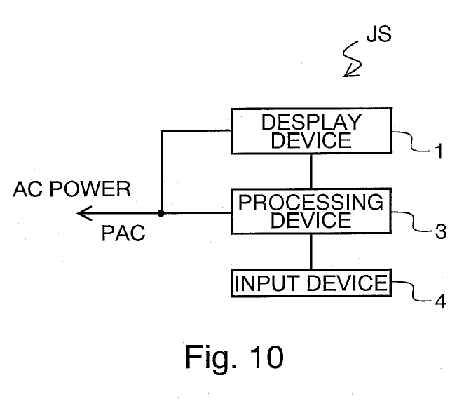

FIG. 10 is a diagram illustrating an example of the structure of an image processing device JS using the display device 1. Referring to FIG. 10, the information processing device JS comprises the display device 1, a processing device 3, and an input device 4. The processing device 3 has a CPU, a RAM, a ROM, another peripheral element, a hard disk device, a DVD device, another storage device or medium drive device, and an interface device for connection to a network as needed. The CPU executes a program (computer program) stored to the RAM or ROM, thereby performing various processing operations. The processing device 3 outputs a video signal S1 to display a video image on the display device 1.

The input device 4 is a keyboard, mouse, or another pointing device. The processing device 3 performs processing operation in accordance with an input instruction from the input device 4, and the display device 1 displays the video image (image) as a processing result. Further, the processing device 3 can output a TV video image and captured photo image and video image, and can also display them on the display device 1.

As the display device (or monitor) 1, the display device described above according to the embodiment is used. Commercial AC voltages PAC are individually supplied to the display device 1 and the processing device 3. However, the commercial AC voltage PAC may be externally supplied to only the processing device 3 and the AC voltage PAC may be supplied to the display device 1 via the processing device 3.

As the processing device 3 and the input device 4, a personal computer can be used.

With the display device 1 described above according to the embodiment, the luminance of the backlight may be controlled in accordance with the video signal with low costs by using a simple circuit. Therefore, the brightness can be automatically adjusted in accordance with display contents of a screen (video image) on the liquid crystal panel unit 12. The dazzle on a screen with a large white area may be suppressed and the power consumption can be reduced.

Irrespective of the type of the display portion such as the liquid crystal panel unit 12, i.e., of the normally white or normally black, the type may be automatically detected and it is possible to correspond to a multi-panel.

According to the embodiment, since an advanced image processing device is not used, the implementing area may be small and the space of a product may be reduced. Further, costs of the device and development costs may be reduced.

According to the embodiment, the case of using the cold-cathode tube 14 for the backlight is described above. A light-emitting diode (LED) is preferable instead of the cold-cathode tube 14. In the case of using the LED, an LED driver is used in place of the inverter 13 for the cathode ray tube and controls the current to the LED. Further, as the display device 1, a touch panel may be attached.

In addition, it is possible to properly modify the components, structure, circuit, shape, the number of parts, function, control contents, and order of the entire or part of the scaler 11, liquid crystal panel portions 12 and 12B, inverter 13, power unit 15, current detecting units 16 and 34, display device 1, and information processing device JS according to the essential of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method for controlling a backlight for illuminating a transmissive display panel comprising:
measuring an amount of current supplied to the transmissive display panel, and
controlling brightness caused by the backlight source on the basis of the amount of the current.

2. The method according to claim 1, further comprising:
storing data of a threshold value to be compared with the amount of the current; and
controlling the brightness to decrease when the transmissive panel is a normally white type and the amount of the current is smaller than the threshold value data or when the transmissive panel is a normally black type and the amount of the current is larger than the threshold value data.

3. The method according to claim 1, further comprising:
controlling the brightness smaller when the transmissive panel is a normally white type and the amount of the current is smaller or when the transmissive panel is a normally black type and the amount of the current is larger.

4. A display device including a transmissive type panel and a backlight comprising:
a detector for detecting an amount of current supplied to the transmissive panel; and
a brightness controller for control brightness caused by the backlight source on the basis of the amount of the current.

5. The display device according to claim 4, wherein the brightness controller compares the amount of current with a threshold value and controls the brightness when the transmissive type panel is a normally white type and the amount of current is smaller than the threshold value or when the transmissive type panel is a normally black type and the amount of current is larger than the threshold value.

6. The display device according to claim 4, wherein the brightness controller controls the brightness smaller when the transmissive panel is a normally white type and the amount of the current is smaller or when the transmissive panel is a normally black type and the amount of the current is larger.

7. The display device according to claim 4, further comprising a determiner for determining that the transmissive panel is the normally white type panel when first current detected by the detector during an entire white image displaying on a screen of the transmissive panel is smaller than second current detected by the detector during an entire black image displaying on a screen of the transmissive panel.

8. The display device according to claim 4, wherein the detector outputs binary signal including two amplitudes according to the amount of current.

9. The display device according to claim 4, wherein the detector outputs a signal including a voltage amplitude according to the amount of current and the bright controller controls the backlight source so as to emit brightness according to the voltage amplitude.

10. The display device according to claim 5, wherein the transmissive panel is a liquid crystal display panel and the amount of current is an amount of current supplied to a source driver of the liquid crystal display.

11. An information processing apparatus comprising:
a display device including a transmissive type panel and a backlight including,
a detector for detecting an amount of current supplied to the transmissive panel,
a brightness controller for control brightness caused by the backlight source on the basis of the amount of the current.
